(19) United States
(12) Patent Application Publication
(10) Pub. No.: US 2013/0273404 A1
(43) Pub. Date: Oct. 17, 2013

(54) BATTERY PACK AND VEHICLE INCLUDING THE SAME

(71) Applicants: Shingo Ochi, Takasago-shi (JP); Atsushi Fujita, Kasai-shi (JP)

(72) Inventors: Shingo Ochi, Takasago-shi (JP); Atsushi Fujita, Kasai-shi (JP)

(73) Assignee: Sanyo Electric., Ltd, Osaka (JP)

(21) Appl. No.: 13/882,308

(22) PCT Filed: Oct. 28, 2011
(86) PCT No.: PCT/JP2011/074945

§ 371 Date: Jun. 3, 2013

(30) Foreign Application Priority Data
Oct. 30, 2010 (JP) 2010-244858

(51) Int. Cl. H01M 2/14

(52) U.S. Cl. CPC H01M 2/14
USPC 429/99

(57) ABSTRACT

A battery pack includes rectangular battery cells and a separator unit. The rectangular battery cells have a rectangular box exterior shape, the thickness of which is smaller than the width. The separator unit prevents the main surfaces of the battery cells from contacting each other, and electrically insulates the battery cells from each other. The battery cells are arranged side by side in the thickness direction as a battery assembly with the main surfaces facing each other. The separator unit includes a first subseparator. The first subseparator includes spacer plates and a support portion. The spacer plates have a size substantially equal to the main surface. The support portion supports the spacer plates with gaps being formed between the spacer plates in the width direction. The gap between the spacer plates is dimensioned so that the battery cell can be inserted into the gap.

### BACKGROUND OF THE INVENTION

1. Technical Field

The present invention relates to a battery pack including a battery assembly constructed of a plurality of rectangular battery cells and separators that are alternately arranged on each other, and a vehicle using this battery pack. The present invention more particularly relates to a battery pack to be installed on an electric vehicle such as hybrid car and electric car and suitable as a power supply for supplying electric power to an electric motor for driving the vehicle, and a vehicle using this battery pack.

2. Description of the Related Art

Large-capacity power supply devices to be used in vehicles include a number of battery cells that are serially connected to each other to increase the output voltage whereby increasing the output electric power. A power supply device has been developed which includes a battery assembly constructed of a number of battery cells that have not a cylindrical shape but a rectangular thin box shape and are arranged side by side in the thickness direction whereby increasing the volumetric charge density of the power supply device (see Japanese Patent Laid-Open Publication No. JP 2010-8688 A).

In this type of power supply device, in the case where the rectangular battery cell includes an exterior container formed metal, the potential of the exterior container is not always zero. For this reason, electrically insulating separators are interposed between the adjacent rectangular battery cells in order to prevent short circuit between the battery cells when the battery cells are arranged side by side in the thickness direction. The separators are formed of resin such as plastic, and have a size substantially equal to the rectangular battery cell.

In the known power supply device, the separators and the rectangular battery cells are alternately arranged on each other one by one. Accordingly, there is a problem that this assembly work is a burden.

In addition, each of the rectangular battery cells includes terminals on its upper surface. After the separators and the rectangular battery cells are alternately arranged on each other so that the battery assembly is constructed, it is necessary to connect the terminals to each other through bus bars. To achieve this, the terminals are formed in a threaded cylindrical shape, while the bus bars have through holes through which the threaded cylindrical-shaped terminals can pass. However, if the rectangular battery cells are deviated from their predetermined positions that will agree with the through holes of the bus bars, the terminals cannot be inserted into the through holes of the bus bars. The positional deviation may prevent the connection between the terminals and the bus bars.

On the other hand, a battery pack has been developed which includes a separator that is integrally formed corresponding to two separators so as to cover two rectangular battery cells on one surface of the separator with the two rectangular battery cells being arranged adjacent to each other in the width direction of the rectangular battery cell (Japanese Patent Laid-Open Publication Nos. JP 2009-272234 A and JP 2010-55908 A). This separator can simplify the assembly work to a certain degree. However, it is still necessary to arrange the separators on the rectangular battery cell in the alternate arrangement direction. As for the alternate arrangement, the burden of the assembly work cannot be reduced. In addition to this, the alternate arrangement of a number of the battery cells and separators may cause the positional deviation.

The present invention is aimed at solving the above problem, and its main object is to provide a power supply device for easy separator assembly and arrangement.

### SUMMARY OF INVENTION

To achieve the above object, a battery pack according to a first aspect of the present invention includes a plurality of rectangular battery cells and a separator unit. The rectangular battery cells have a rectangular box exterior shape the thickness of which is smaller than the width. The separator unit prevents the main surfaces of the plurality of rectangular battery cells from contact with each other, and electrically insulates the rectangular battery cells from each other. The rectangular battery cells are arranged side by side in the thickness direction of the battery cells as a battery assembly with the main surfaces facing to each other. The separator unit includes a first subseparator. The first subseparator includes a plurality of spacer plates and a support portion. The spacer plates have a size substantially equal to the main surface of the rectangular battery cell. The support portion supports the plurality of spacer plates with gaps being formed between the spacer plates in the width direction of the rectangular battery cells. The gap between the spacer plates is dimensioned so that the rectangular battery cell can be inserted into the gap. According to this construction, since a plurality of spacer plates of the first subseparator are previously supported, the battery assembly can be easily assembled by inserting the rectangular battery cells into the gaps between the spacer plates. In addition to this, since the first subseparator is previously accurately shaped, the spacer plates can be accurately positioned irrespective of the alternate arrangement of the rectangular battery cells. Therefore, there is an advantage that bus bars, and the like can be easily coupled to the battery cells.

In a battery pack according to a second aspect of the present invention, the support portion can cover the bottom surface of the battery assembly. According to this construction, there is an advantage that the rectangular battery cells can be easily inserted into the support portion.

In a battery pack according to a third aspect of the present invention, the support portion can at least partially cover the upper surface of the battery assembly. According to this construction, there is an advantage that the spacer plates can be easily inserted into gaps between the rectangular battery cells that are arranged in place.

In a battery pack according to a fourth aspect of the present invention, bus bars can be further provided which connect terminals on the upper surfaces of the rectangular battery cells to each other. The separator unit can further include an electrically insulating second subseparator that holds the bus bars at predetermined positions, and is arranged on the upper surface of the battery assembly. The terminals can be connected to each other through the bus bars by coupling the second subseparator to the first subseparator. According to this construction, the bus bar can be positioned by the second subseparator. When the second subseparator is coupled to the separator, the bus bars can connect the terminals to each other. Therefore, there is an advantage that the bus bars and the terminals can be very easily connected to each other.

In a battery pack according to a fifth aspect of the present invention, the second subseparator can include a second subseparator main portion, and a bus bar portion. The bus bar portion is arranged on the upper surface of the second subseparator main portion, and provided separately from the second subseparator main portion. The bus bars are held by the bus bar portion. According to this construction, since the second subseparator is constructed of the separated parts including the bus bar portion, there is an advantage that the bus bars can be easily and safely coupled to the rectangular battery cells. The second subseparator may include a second subseparator main portion that extends in the central part on the upper surface of the battery assembly in the width direction, and first and second bus bar portions that are arranged on the right and left side of the second subseparator main portion and hold the bus bars.

In a battery pack according to a sixth aspect of the present invention, the bus bar portion can be constructed of a plurality of separated bus bar block parts. According to this construction, even in the case where a number of rectangular battery cells are arranged in the width direction, the bus bar portion can be constructed of an easy-to-handle number of separated parts. Therefore, there is an advantage that the bus bar can be more easily coupled to the battery cells.

In a battery pack according to a seventh aspect of the present invention, the second subseparator main portion can be constructed of a plurality of separated subseparator block parts. According to this construction, even in the case where a number of rectangular battery cells are arranged in the width direction, an easy-to-handle number of spacer plates can be supported by the separated subseparator block parts. Therefore, there is an advantage that the rectangular battery cells can be more easily inserted into the gaps between the spacer plates.

In a battery pack according to an eighth aspect of the present invention, the bus bars can be integrally formed with the second subseparator by insert molding. According to this construction, there is an advantage that the bus bars can be firmly held in the second subseparator.

In a battery pack according to a ninth aspect of the present invention, the bus bars can be integrally formed with the second subseparator by outsert molding. According to this construction, there is an advantage that the bus bars can be held in the second subseparator at low cost.

In a battery pack according to a tenth aspect of the present invention, a pair of end plates and bind bars can be further provided. The end plates are arranged on the end surfaces of the width direction of the rectangular battery cells and the spacer plates, which are alternately arranged so that the spacer plates are sandwiched between the battery cells, of the battery assembly. The metal bind bars securely couple the end plates, which are arranged on the end surfaces of the battery assembly, to each other. According to this construction, when the end plates are coupled to each other through the bind bars, the battery assembly can be securely held.

A vehicle according to an eleventh aspect of the present invention includes the aforementioned power supply device.

The above and further objects of the present invention as well as the features thereof will become more apparent from the following detailed description to be made in conjunction with the accompanying drawings.

### BRIEF DESCRIPTION OF DRAWINGS

FIG. 1 is a perspective view showing a battery pack according to a first embodiment of the present invention.

FIG. 2 is an exploded perspective view showing the battery pack shown in FIG. 1.

FIG. 3 is an enlarged perspective view showing rectangular battery cells shown in FIG. 1.

FIG. 4 is an exploded perspective view showing a battery pack according to a second embodiment of the present invention.

FIG. 5 is an exploded perspective view showing a battery pack according to a third embodiment of the present invention.

FIG. 6 is an exploded perspective view showing a battery pack according to a fourth embodiment of the present invention.

FIG. 7 is an exploded perspective view showing a battery pack according to a fifth embodiment of the present invention.

FIG. 8 is a block diagram showing an exemplary hybrid car that is driven by an internal-combustion engine and an electric motor, and includes a battery system.

FIG. 9 is a block diagram showing an exemplary electric car that is driven by only an electric motor, and includes a battery system.

### DETAILED DESCRIPTION OF THE INVENTION

The following description will describe embodiments according to the present invention with reference to the drawings. It should be appreciated, however, that the embodiments described below are illustrations of a battery pack and a vehicle including this battery pack to give a concrete form to technical ideas of the invention, and a battery pack and a vehicle including this battery pack of the invention are not specifically limited to description below. Furthermore, it should be appreciated that the members shown in claims attached hereto are not specifically limited to members in the embodiments. Unless otherwise specified, any dimensions, materials, shapes and relative arrangements of the members described in the embodiments are given as an example and not as a limitation. Additionally, the sizes and the positional relationships of the members in each of drawings are occasionally shown larger exaggeratingly for ease of explanation. Members same as or similar to those of this invention are attached with the same designation and the same reference signs, and their description is omitted. In addition, a plurality of structural elements of the present invention may be configured as a single part that serves the purpose of a plurality of elements, on the other hand, a single structural element may be configured as a plurality of parts that serve the purpose of a single element. Also, the description of some of examples or embodiments may be applied to other examples, embodiments or the like.

### First Embodiment

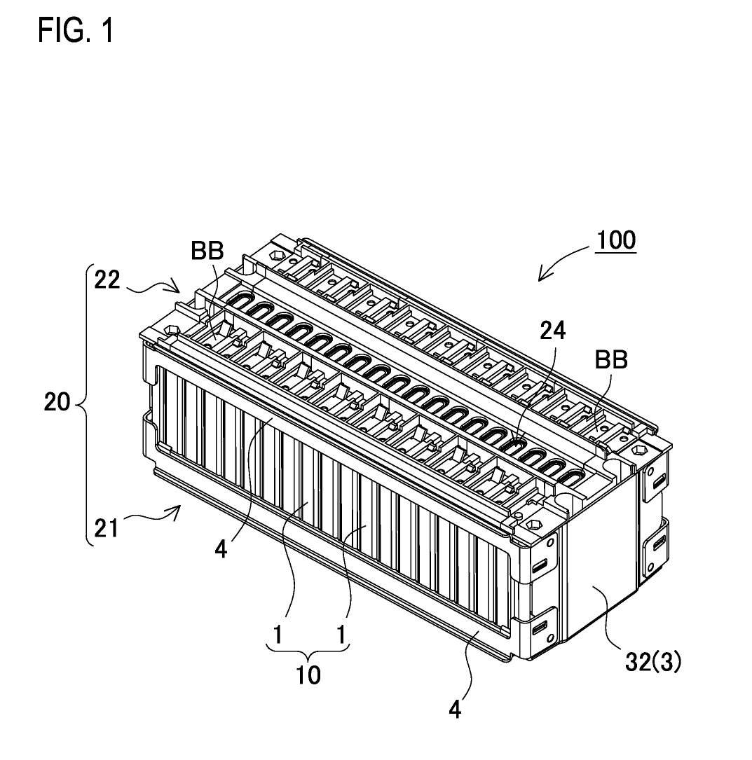

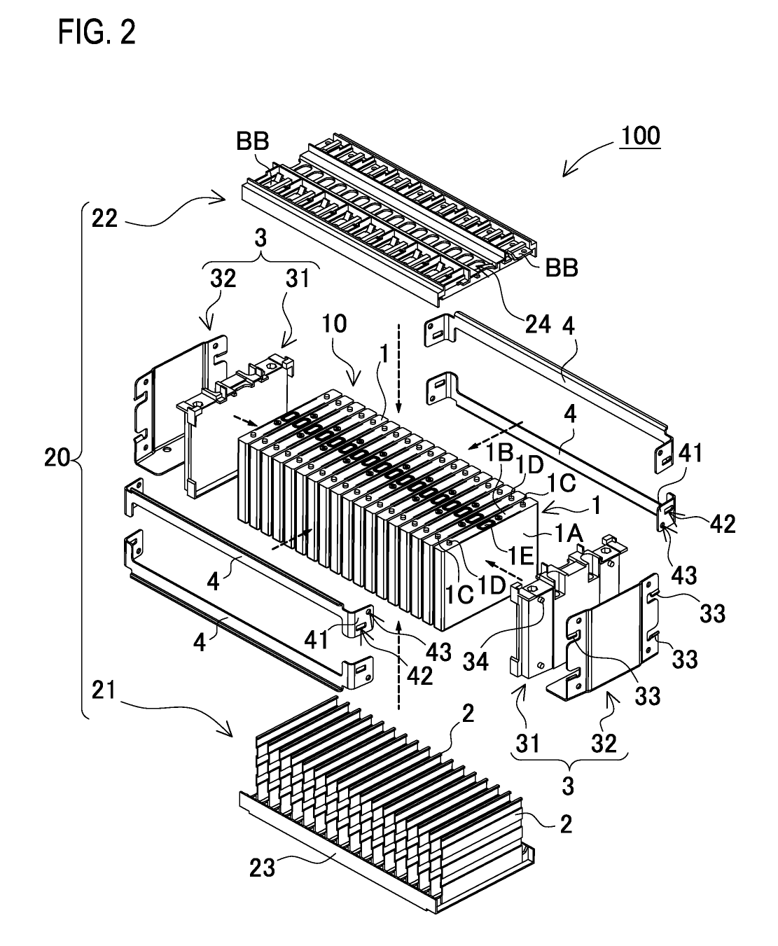

FIG. 1 is a perspective view showing a battery pack according to a first embodiment of the present invention. FIG. 2 is an exploded perspective view showing the battery pack. The illustrated battery pack 100 includes a battery assembly 10, end plates 3, and bind bars 4. In the battery assembly, a plurality of rectangular battery cells 1 and spacer plates 2 are alternately arranged on each other. The end plates cover the end surfaces of the battery assembly 10. The bind bars 4 couple the end plates 3 to each other. As shown in FIG. 1, the battery pack 100 has a substantially box-shaped outward appearance. A number of rectangular battery cells 1 are arranged in the width direction. The battery cells are securely held between the end plates 3, which are arranged on the both end surfaces of the battery assembly, through the bind bars 4. In the battery assembly 10, as shown in the exploded perspective view of FIG. 2, the separator plates 2 are sandwiched between the rectangular battery cells 1. In the battery block 10 shown in FIGS. 1 and 2, eighteen rectangular battery cells 1 are arranged in the width direction, and serially connected to each other.

### (Rectangular Battery Cell 1)

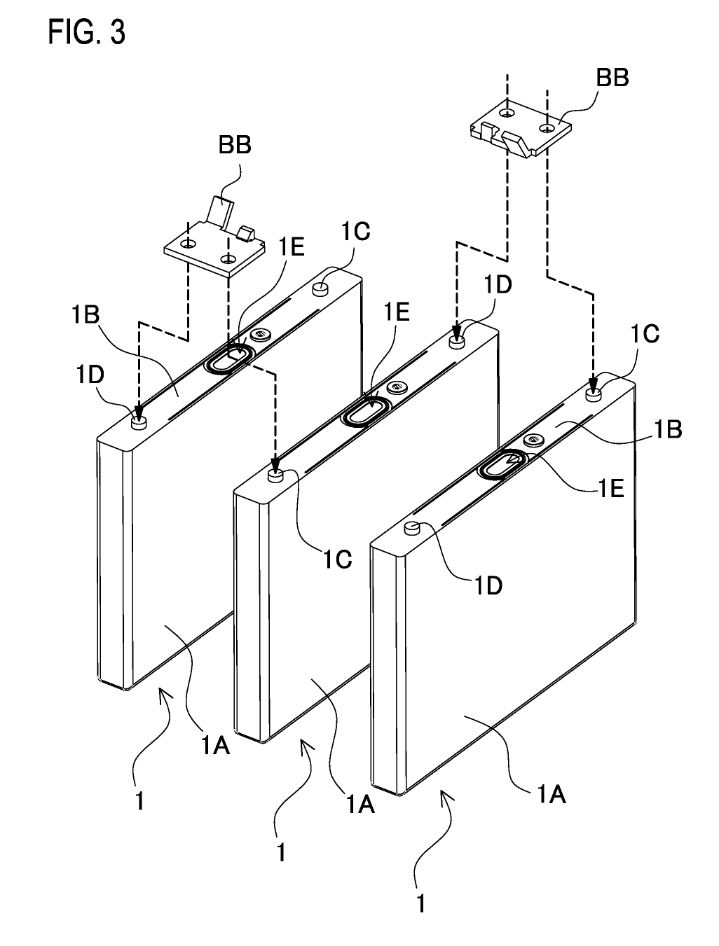

As shown in FIG. 3, the rectangular battery cell 1 is constructed of an exterior container 1A that has an exterior shape with a thickness smaller than its width. The battery cell includes the positive/negative terminals that are arranged on a sealing plate 1B. The sealing plate closes the top opening of the exterior container 1A. In other words, the sealing plate seals the exterior container. In this embodiment, the positive and negative terminals 1D and 1C are arranged on the end parts of the sealing plate 1B. The terminals are electrically connected to each other through bus bars BB. The positive/negative terminals of the rectangular battery cells 1, which are arranged in the width direction, are serially connected to each other through the bus bars BB. In the case of a battery system in which the adjacent rectangular battery cells 1 are serially connected to each other, the output voltage of the battery system can be high, and as a result the battery system can provide high power. However, in the battery system according to the present invention, adjacent rectangular batteries may be connected in parallel to each other.

A safety valve 1E is arranged in the central part of the sealing plate 1B.

When an internal pressure in the exterior container 1A rises, the safety valve will open so that gas can be discharged. In order that gas can safely be exhausted, a duct (not shown) is connected to the safety valve 1E. In addition, the surfaces except the top surface of the rectangular battery cell 1 are subjected to an electrically insulating process. Specifically, the surfaces other than the top and bottom surfaces of the rectangular battery cell 1 are covered with a covering film. The rectangular battery cells 1 are lithium-ion rechargeable batteries. However, the battery cells may be nickel metal hydride battery batteries or nickel-cadmium batteries.

### (End Plate 3)

The pair of end plates 3 are arranged on the both end surfaces of the battery assembly 10 of the rectangular battery cells 1 with the separator plates 2 being sandwiched between the battery cells. When the pair of end plates 3 are firmly coupled to each other, the battery assembly 10 is securely held between the pair of end plates. The end plate 3 shown in FIG. 2 is constructed of a main portion 31, and a metal plate 32 that is arranged on the outside surface of the main plate. The main portion is formed of plastic by molding. The metal plate is formed of metal such as aluminum. It will be appreciated that the end plate may be entirely formed of metal or plastic. Protrusions 33 are arranged in the four corner parts of the surface of the metal plate 32, which is located on the outside surface of the main portion of the end plate 3. The bind bars 4 can engage with the protrusions. In addition, the main portion 31, which is located on the inside surface of the metal plate, includes positioning pins 34 that position the metal plate 32, and prevent the bind bars 4 from pivoting with the protrusions 33 of the end plate 3 being inserted into slits 42 of the bind bars 4.

### (Bind Bar 4)

The bind bars 4 serves as fasteners for fastening the rectangular battery cells 1. In this embodiment, the both end parts of the elongated metal plate are bent so that metal plate has a rectangular U shape as viewed from the top side.

The both end parts serve as bent parts 41. The bent part 41 has the slit 42 into which the protrusion 33 of the end plate 3 can be inserted. In addition, the bind bars have pin openings 43 into which the positioning pins 34 on the end plate 3 can be inserted.

Thus, the bind bars 4 couple the end plates 3 to each other, and securely hold the side surfaces of the battery assembly so that the end plates are in press contact with the both end surfaces of the battery assembly including the battery cells 1 with the separator plates 2 being sandwiched between the battery cells. Specifically, when the protrusions 33 of the end plates 3 engage with the slits 42 of the bent parts 41 of the bind bars 4, the rectangular battery cells 1 are arranged in the width direction, and brought in press contact with the end plates 3 with the separator plates 2 being sandwiched between the rectangular battery cells 1.

The engagement structure between the bind bar 4 and the end plate 3 is not limited to this. Known engagement structures can be suitably used including a threaded-engagement structure that uses a screw so that the bind bar is fastened to the end plate.

### (Separator Unit 20)

In the battery assembly 10, the separator plates 2 are sandwiched between the rectangular battery cells 1, which are arranged in the width direction. The plurality of rectangular battery cells 1 are arranged side by side in the thickness direction of the battery cells with the main surfaces facing to each other. The separator unit is arranged between the main surfaces of the rectangular battery cells 1 and prevents the rectangular battery cells from contact with each other whereby electrically insulating the rectangular battery cells 1 from each other. The spacer plates 2 are not individually inserted into gaps between the rectangular battery cells, but a separator unit 20 is used which includes the spacer plates that are integrally formed. The separator unit 20 is constructed of a plurality of separated subseparators. The separator unit according to the first embodiment shown in FIG. 2 is constructed of two separated parts as the first and second subseparators 21 and 22.

### (First Subseparator 21)

The first subseparator 21 is constructed of a plurality of spacer plates 2, and a support portion 23. The spacer plates are arranged substantially in parallel to each other, and spaced substantially at a fixed interval away from each other. The support portion supports the spacer plates 2. Each of the spacer plates 2 corresponds to the known single separator, and can be inserted into the gap between rectangular battery cells 1 so that the battery cells are electrically and thermally insulated from each other. The spacer plates 2 have a size substantially equal to a main surface of the rectangular battery cell. The spacer plate 2 is not flat but has a shape that is obtained by connecting rectangular U shapes that are alternately orientated frontward and rearward as viewed the side of the spacer plate so that gaps can be formed between the rectangular battery cells 1 and the spacer plate 2 when the battery cells are in contact with the separator plate. Accordingly, cooling gas such as air can pass through the gaps so that the rectangular battery cells 1 can be cooled. In the case where the spacer plate 2 is formed in a shape that is obtained by deforming a plate shape, the cooling gaps for cooling the battery cells can be formed between the spacer plates 2 and the rectangular battery cells 1 when the rectangular battery cells 1 are alternately arranged on the spacer plates. In addition, a blower mechanism (not shown) is provided as a cooling mechanism that forcedly blows cooling gas to cool the rectangular battery cells 1 of the battery assembly 10.

The first subseparator 21 may serve as a cooling plate. In other words, instead of the air cooling system, a system may be used which includes the cooling plate as the first subseparator, which is in contact with the bottom surface of the battery assembly 10 and is cooled by coolant or the like so that the battery assembly 10 directly is cooled. In this case, the cooling plate can be formed as the base portion 21A on which the battery cells are be arranged in the width direction. In the case where this coolant-type cooling system is used, the air-cooling gaps can be omitted. For this reason, the flat spacer plates 2 can be used which are inserted into gaps between the rectangular battery cells 1, and electrically and thermally insulate the rectangular battery cells 1 from each other.

The gap between the spacer plates 2 of the support portion 23 for supporting the spacer plates 2 is dimensioned so that the rectangular battery cell 1 can be inserted into the gap. In this embodiment, the support portion 23 is dimensioned to cover the bottom surface of the battery assembly 10. The spacer plates 2 of the first subseparator 21 are inserted into the gaps between the rectangular battery cells 1 from top side, right side or left side. Thus, the battery assembly 10 is constructed. It is preferable that the first subseparator 21 be integrally formed of an electrically insulating material such as resin. Accordingly, the rectangular battery cells 1 can be accurately positioned and arranged in the width direction. In particular, in the case where the support portion 23 is arranged on the bottom surface of the rectangular battery cell 1, the rectangular battery cells 1 can be aligned at the same vertical position so that the sealing plates 1B as the top surfaces of the battery cells can be arranged coplanar. As a result, the bus bars BB can be stably coupled to the battery cells. The known battery assembly does not include a member that supports the rectangular battery cells and restricts vertical positional deviation of the battery cells. For this reason, the top and bottom surfaces of the battery cells may not be arranged coplanar. As a result, it is not easy to stably couple the bus bars to the battery cells and to bring the bottom surfaces of the battery cells in the same contact condition when the battery cells are in contact with the cooling plate. In particular, in the case where the known battery pack is used for vehicles, although the battery cells are held by the bind bars, the battery cells may be deviated in the vertical direction. If the battery pack is used for a long time, the reliability of the battery pack may decrease. Contrary to this, since the rectangular battery cells 1 according to the first embodiment are arranged on the upper surface of the support portion 23, the possibility of such positional deviation is almost zero. Therefore, there is an advantage that the rectangular battery cells 1 can be stably held at the same vertical position for a long time.

In addition, since the main surface of the rectangular battery cell 1 is sandwiched between the spacer plates 2, the movement of the battery cell is restricted in the width direction. Also, expansion of the rectangular battery cell 1 can be suppressed. Also, it is not necessary to alternately arrange the separators on the rectangular battery cells 1 one by one when the battery pack is assembled. Therefore, the battery pack can be easily and quickly assembled.

### (Second Subseparator 22)

The lower-surface of the battery assembly 10 is supported by the first subseparator 21, while the upper surface of the battery assembly 10 is covered by the second subseparator 22. The second subseparator 22 covers the upper surfaces of the rectangular battery cells 1, and holds the bus bars BB, which connect the terminals of the adjacent rectangular battery cells 1 to each other. The second subseparator 22 is fastened to the first subseparator 21. Thus, the top and bottom surfaces and main surfaces of the rectangular battery cells 1 can be protected. The side surface sides of the battery assembly 10 are exposed. Accordingly, cooling gas can pass through the gaps between the rectangular battery cells 1 through the side surface sides so that the battery assembly 10 can be cooled. The first subseparator 21 can be fastened to the second subseparator 22 by screws, fit-in structures, an adhesive, or the like.

It is preferable that the bus bar BB be previously held by the second subseparator 22. Accordingly, when the second subseparator 22 is coupled and fastened to the first subseparator 21, the bus bars BB can be coupled to the battery cells. Since the rectangular battery cells 1 are positioned and held by the first subseparator 21, while the bus bars BB are positioned and held by the second subseparator 22, when the first and second subseparators are fastened to each other, the bus bars BB can be arranged at their predetermined positions of the rectangular battery cells 1. Therefore, there is an advantage that the burden of the coupling work of the bus bars BB can be substantially reduced. The bus bar BB can be securely held to the second subseparator 22 for example by insert molding or outsert molding.

The second subseparator 22 has gas exhaust openings 24 that are arranged along the center line at the positions corresponding to the safety valves 1E of the rectangular battery cells 1 as shown in FIGS. 1 and 2. According to this construction, the upper surface of the battery assembly 10 is covered by the second subseparator, while the gas that is discharged from the rectangular battery cell 1 can be guided through the gas exhaust opening 24 to the outside. The gas exhaust opening 24 communicates with the gas duct (not shown) to the outside of the vehicle, for example. In addition, the bus bars BB are held in the second subseparator on the both sides of the center line along which the gas exhaust openings 24 are aligned. The second subseparator 22 may be integrally formed with the gas duct.

### Second Embodiment

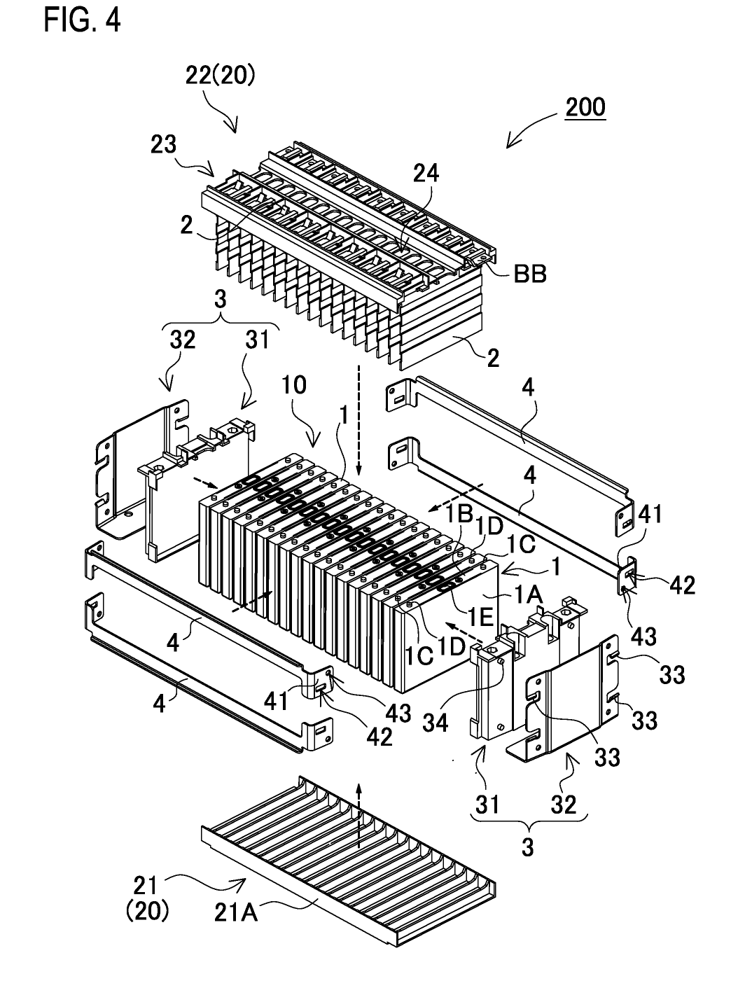

In the foregoing embodiment, it has been illustratively described that the first subseparator 21 securely holds the spacer plates 2 to be inserted into the gaps between the rectangular battery cells 1. However, the present invention is not limited to this. The second subseparator can securely hold the spacer plates. FIG. 4 shows this type of battery pack according to a second embodiment. This illustrated battery pack 200 includes a separator unit 20 is constructed of two separated parts as the first and second subseparators 21 and 22. The first subseparator 21 is constructed of only a base portion 21A that corresponds to a base member. The second subseparator 22 includes the support portion 23, which supports the spacer plates 2. The spacer plates 2 protrude from the lower surface of the support portion, and are spaced at an interval away from each other. The other members have substantially the same construction as the member shown in FIG. 2. The other members of the battery pack same as those of the battery pack shown in FIG. 2 are attached with the same reference signs, and their description is omitted. In the battery pack 200, after the rectangular battery cells 1 are arranged on the base portion 21A of the first subseparator 21, the second subseparator 22 is moved downward from the top side so that the spacer plates 2 are inserted into the gaps between the rectangular battery cells 1. The second subseparator 22 is then fastened to the first subseparator 21. According to this construction, the rectangular battery cells 1 can be easily arranged on the base portion 21A. After the rectangular battery cells 1 are arranged on the first subseparator 21, the second subseparator 22 can be arranged and fastened to the first subseparator. Therefore, there is an advantage that the work can be easy. Also, the spacer plates 2 and the bus bars BB are securely held by the second subseparator 22 so that the spacer plates and the bus bars are previously positioned in place. Therefore, there is an advantage that the spacer plates and the bus bars can be more accurately and reliably positioned.

### Third Embodiment

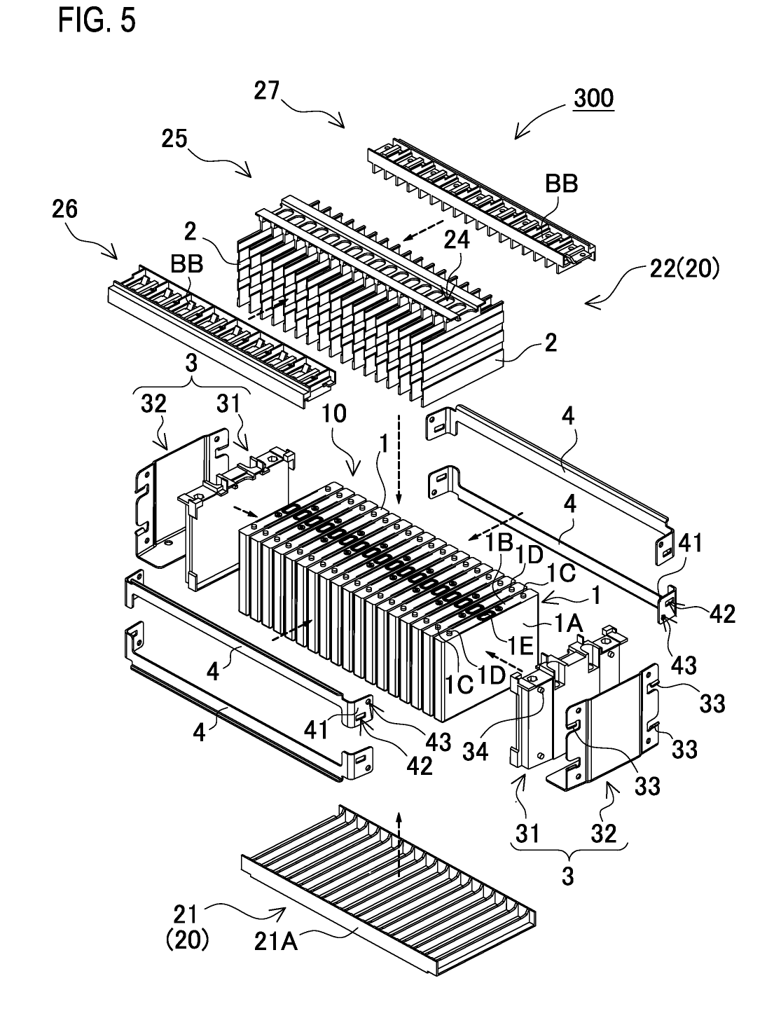

In the second embodiment, it has been described that the second subseparator 22 is integrally formed. However, the second subseparator can be constructed of a plurality of separated members. FIG. 5 shows this type of battery pack according to a third embodiment. The illustrated battery pack 300 includes a second subseparator main portion 25, and first and second bus bar portions 26 and 27. The gas exhaust openings 24 are formed along a central part that extends on the top side of the second subseparator main portion. The first and second bus bar portions are separately provided from the second subseparator main portion, and arranged beside the central part of the second subseparator main portion. The bus bars BB are held in the first and second bus bar portions 26 and 27. In the case where the member for holding the bus bars are separately provided from the subseparator main portion, there is an advantage that the bus bars can be easily coupled to the battery cells. That is, although the first and second bus bar portions 26 and 27 having the bus bars BB are formed by insert molding or outsert molding, the second subseparator main portion 25 can be formed by normal resin molding. As a result, the second subseparator can be efficiently produced. Also, since the bus bar portions are separately provided from the subseparator main portion, the positive and negative terminals of the rectangular battery cell can be separately connected to battery cells adjacent to this battery cell. For this reason, it is possible to more surely avoid an unintentional short circuit, or the like, as compared with the case where the positive and negative terminals of the rectangular battery cell are connected to battery cells adjacent to this battery cell at the same time. Therefore, it is advantageous to ensure the safety in the assembly work.

### Fourth Embodiment

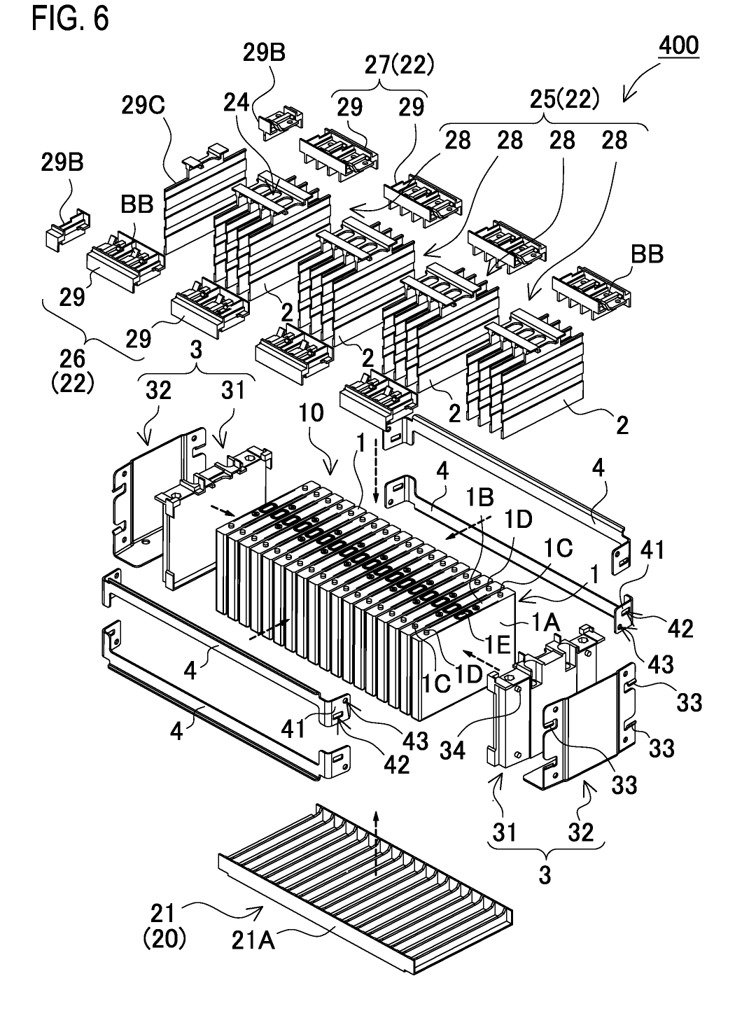

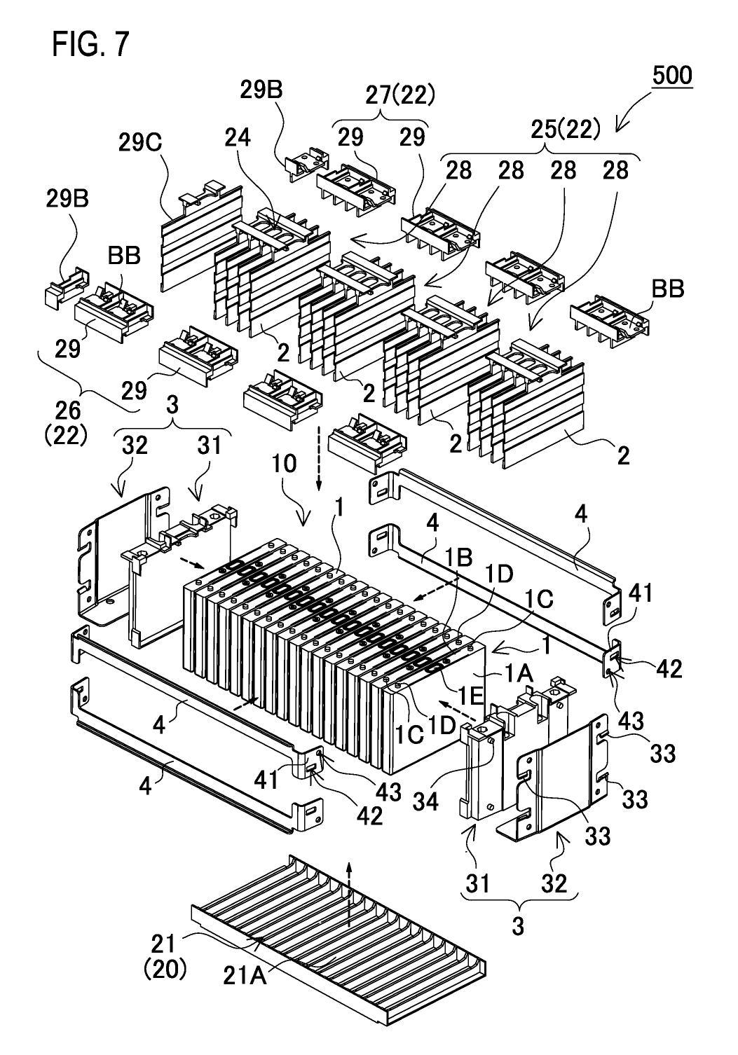

Each of the first and second bus bar portions 26 and 27, and the second subseparator main portion 25 is not always required to be integrally formed. Each of the first and second bus bar portions, and the second subseparator main portion can be constructed of separated parts. FIG. 6 shows this type of battery pack according to a fourth embodiment. In this illustrated battery pack 400, the second subseparator main portion 25 is constructed of a plurality of separated subseparator block parts 28. Also, each of the first bus bar portion 26 and the second bus bar portion 27 is constructed of a plurality of separated bus bar block parts 29. In this embodiment, each of the separated subseparator block parts 28 includes four spacer plates 2 and three gas exhaust openings 24, and can accommodate three rectangular battery cells 1. The second subseparator main portion 25 can be constructed by coupling four subseparator block parts 28 to each other. Similarly, each of the separated bus bar block parts 29 holds four bus bars BB. Each of the first bus bar portion 26 and the second bus bar portion 27 is formed by coupling four bus bar block parts 29 to each other. In addition to these parts to be coupled to each other, additional members can be provided on the end surface side. In the embodiment of FIG. 7, an end surface bus bar part 29B is coupled to the end surface of each of the first bus bar portion 26 and the second bus bar portion 27. Also, an end surface separator 29C is coupled to the end surface of the second subseparator main portion 25. According to this construction, since each of the first and second bus bar portions, and the second subseparator main portion is constructed of separated relatively small parts, there is an advantage that the battery pack can be easily assembled. Generally, as the number of the rectangular battery cells increases, the difficulty will increase in insertion work of the spacer plate into the gap between the rectangular battery cells. In particular, in the case where the battery pack includes a number of rectangular battery cells that are arranged in the width direction in order to provide high output, the efficiency of assemble work of the battery pack may decrease even as compared with the case where the known battery pack is assembled by arranging the separators on the battery cells one by one. To address this problem, the second subseparator main portion or the bus bar portion is constructed of separated parts that are easily handled so that the workability can be improved. Although it has been illustratively described that each of the subseparator block part 28 and the bus bar block parts 29 accommodates three rectangular battery cells in the battery pack shown in FIG. 6, the number of the battery cells to be accommodated in each of the parts can be suitably changed to two, or four or more.

### Fifth Embodiment

Although it has been illustratively described that the bus bars are held in the bus bar block parts 29 by insert molding in the embodiment shown in FIG. 6, the present invention is not limited to this. Needless to say, the bus bars can be held in the bus bar block parts by outsert molding. FIG. 7 shows this type of battery pack 500 according to a fifth embodiment. In the case of insert molding, the bus bar BB is embedded in resin of the bus bar block part 29. Accordingly, the bus bar can be securely held by the bus bar block part. On the other hand, in the case of outsert molding, after the bus bar block part 29 is formed of resin, the bus bar BB can be fastened to the bus bar block part. Accordingly, the manufacturing cost can be low. Insert and outsert molding type bus bar block parts 29 have different advantages. For this reason, insert or outsert molding type bus bar block parts can be suitably selected depending on required specifications.

As discussed above, since the separator unit is used which includes the spacer plates 2 that are previously positioned in the separator unit, the assembly work efficiency can be improved. In addition, the rectangular battery cell can be reliably and easily positioned. As a result, there is an advantage that the bus bars, and the like can be easily coupled to the battery cells.

### (Vehicle Using Power Supply Device)

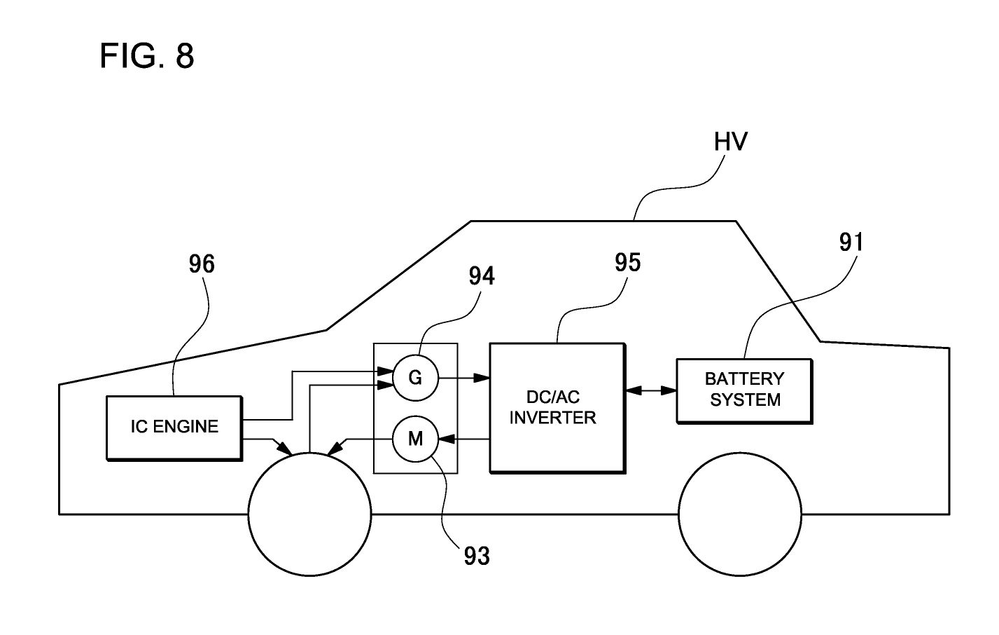

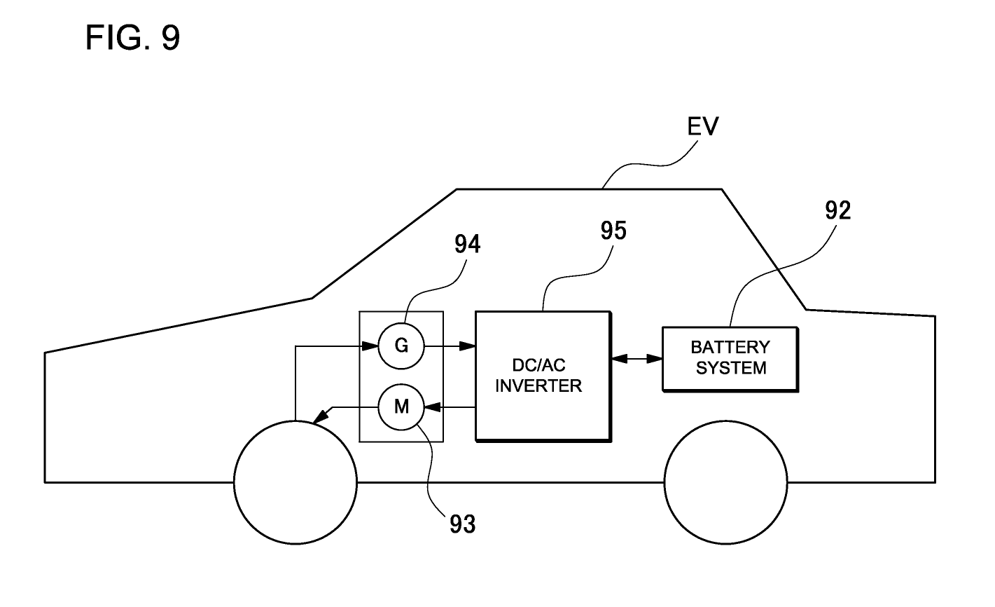

With reference to FIGS. 8 and 9, a vehicle is now described which includes the aforementioned power supply device using the rectangular battery cells. FIG. 8 shows a hybrid car HV as the vehicle that includes the vehicle battery system, and is driven both by an internal-combustion engine 96 and an electric motor 93. The illustrated hybrid car includes the internal-combustion engine 96, the electric motor 93, the battery system 91, and an electric generator 94. The internal-combustion engine 96 and the electric motor 93 drive the vehicle. The battery system supplies electric power to the electric motor 93. The electric generator 94 charges batteries of the battery system 91. The battery system 91 is connected to the electric motor 93 and the electric generator 94 through a DC/AC inverter 95. The hybrid car is driven both by the electric motor 93 and the internal-combustion engine 96 with the batteries of the battery system 91 being charged/discharged in traveling. The electric motor 93 is energized and drives the vehicle in a poor engine efficiency range, e.g., in acceleration or in a low speed range. The electric motor 93 is energized by electric power that is supplied from the battery system 91. The electric generator 94 is driven by the engine 96 or by regenerative braking during vehicle braking so that the batteries of the battery system 91 are charged.

FIG. 9 shows an electric car EV as the vehicle that includes the vehicle battery system, and is driven only by the electric motor 93. The illustrated electric car includes the electric motor 93, the battery system 92, and the electric generator 94. The electric motor 93 drives the vehicle. The battery system supplies electric power to the electric motor 93. The electric generator 94 charges batteries of the battery system 92. The battery system 92 is connected to the electric motor 93 and the electric generator 94 through a DC/AC inverter 95. The electric motor 93 is energized by electric power that is supplied from the battery system 92. The electric generator 94 can be driven by vehicle regenerative braking so that the batteries of the battery system 92 can be charged.

A battery pack according to the present invention can be suitably used as power supply devices of plug-in hybrid vehicles and hybrid electric vehicles that can switch between the EV drive mode and the HEV drive mode, electric vehicles, and the like. A vehicle including this battery pack according to the present invention can be suitably used as plug-in hybrid vehicles, hybrid electric vehicles, electric vehicles, and the like.

1-11. (canceled)

12. A battery pack comprising:
a plurality of rectangular battery cells that have a rectangular box exterior shape the thickness of which is smaller than the width; and
a separator unit that prevents the main surfaces of said rectangular battery cells from contact with each other, and electrically insulates the rectangular battery cells from each other, said plurality of rectangular battery cells being arranged side by side in the thickness direction of the battery cells as a battery assembly with the main surfaces facing to each other,
wherein said separator unit includes a first subseparator,
wherein the first subseparator includes
a plurality of spacer plates that have a size substantially equal to the main surface of said rectangular battery cell, and
a support portion that covers the bottom surface of said battery assembly and supports said spacer plates with gaps being formed between the spacer plates in the width direction of said rectangular battery cells,
wherein the spacer plates can be inserted into the gap between the rectangular battery cells with the rectangular battery cells being aligned relative to the support portion,
wherein the gap between the spacer plates is dimensioned so that said rectangular battery cell can be inserted into the gap.

13. The battery pack according to claim 12, further comprising
terminals that are included in said rectangular battery cells and arranged on the upper surfaces of said battery assembly, and
bus bars that connect said terminals to each other,
wherein said separator unit further includes an electrically insulating second subseparator that at least partially covers the upper surface of the battery assembly,
wherein said second subseparator includes bus bar portions that hold said bus bars.

14. The battery pack according to claim 12, wherein said terminals can be connected to each other through said bus bars by coupling said second subseparator to said first subseparator.

15. The battery pack according to claim 14, wherein
said second subseparator includes
a second subseparator main portion, and
a bus bar portion that is arranged on the upper surface of said second subseparator main portion, and provided separately from the second subseparator main portion, wherein said bus bars are held by the bus bar portion.

16. The battery pack according to claim 15, wherein said bus bar portion is constructed of a plurality of separated bus bar block parts.

17. The battery pack according to claim 15, wherein said second subseparator main portion is constructed of a plurality of separated subseparator block parts.

18. The battery pack according to claim 14, wherein said bus bars are integrally formed with said second subseparator by insert molding.

19. The battery pack according to claim 14, wherein said bus bars are integrally formed with said second subseparator by outsert molding.

20. The battery pack according to claim 12, further comprising
a pair of end plates that are arranged on the end surfaces of the width direction of said rectangular battery cells and said spacer plates, which are alternately arranged so that the spacer plates are sandwiched between the battery cells, of the battery assembly, and
metal bind bars that securely couple said end plates, which are arranged on the end surfaces of said battery assembly, to each other.

21. A vehicle comprising the battery pack according to claim 12.
